(19) United States
(12) Patent Application Publication
(10) Pub. No.: US 2001/0023401 A1
(43) Pub. Date: Sep. 20, 2001

(54) Method and apparatus for rating database objects

(76) Inventors: Gideon Martin Reinier Weishut, Eindhoven (NL); Duco Annardo David Das, Eindhoven (NL); Lucas Jacobus Franciscus Geurts, Eindhoven (NL); Herman Jan Ter Horst, Eindhoven (NL); Erik Gerardus Hubertus Bastiaans, Eindhoven (NL)

Correspondence Address: Corporate Patent Counsel, U.S. Philips Corporation, 580 White Plains Road, Tarrytown, NY, 10591, US

(21) Appl. No.: 09/804,003

(22) Filed: Mar. 12, 2001

(30) Foreign Application Priority Data
Mar. 17, 2000 (EP) 00200972.8

(51) Int. Cl. G06F 17/60

(52) U.S. Cl. 705/1; 705/7

(57) ABSTRACT

The invention relates to a method of rating database objects, such as broadcast programs in an EPG database. The objects are categorized in accordance with a multi-level category scheme with a first level of categories and a second level of categories subordinate to a respective category of the first level. The rating of a category of the first level is computed as a function , for example the average, of ratings of subordinate categories of the second level. Ratings are visually represented as different colors or different degrees of saturation of the same color.

### FIELD OF THE INVENTION

The invention relates to a method of rating database objects, comprising a step of categorizing the objects into a plurality of categories, and a step of rating at least one of said categories.

The invention further relates to an apparatus for carrying out the above method.

The invention further relates to a computer program product for performing, when executed on a programmable computing device, the steps of the above method.

### BACKGROUND OF THE INVENTION

A method of the above type is, for example, applied in a known television receiver comprising an electronic program guide (EPG) and user profile means which enable the user to assign a rating to various program genres, such as sports and movies. Based on these ratings, the known television receiver can then recommend certain programs in the EPG database to the user. For example, all programs in the EPG database having a genre with a rating above average may be included in a recommendation list which can be displayed on the TV screen. Ratings are generally integers which can be chosen from a limited range, for example from −3 to +3, the negative values expressing various degrees of dislike, zero expressing a neutral rating and the positive values expressing various degrees of preference. Ratings can be assigned explicitly by the user, or generated by the television receiver based on viewing behavior.

A disadvantage of the known method is that such a rating system is often too coarse for a user to express his preferences in a proper way.

### OBJECT AND SUMMARY OF THE INVENTION

It is an object of the invention to provide an improved system and method of the type defined in the opening paragraph. To that end, the method according to the invention is characterized in that the method further comprises a step of arranging the categories in accordance with a multi-level category scheme with a first level of categories and a second level of categories subordinate to a respective category of the first level, and a step of computing a rating of a category of the first level as a function of ratings of subordinate categories of the second level. In this way it is achieved that the user can assign ratings to both main categories and subcategories, which provides a much more sophisticated means for expressing user preferences. For example, a user may express a preference for TV programs of the genre ‘series’, but assign a negative rating to series of the sub-genre ‘soap’. As a result, the TV will recommend programs of the genre ‘series’ except for programs of the sub-genre ‘soap’.

Inconsistencies between ratings of both levels are avoided according to the invention by computing ratings of the first level as a function of ratings of subordinate categories of the second level. For example, if the user adjusts a rating of one or more categories of the second level, the rating of the related category of the first level is recomputed in accordance with said function. The rating of a category of the first level is thus an indication of the ratings of the respective subordinate categories of the second level. This rating may, for example, be used for recommending objects, e.g. TV programs, for which there is no category of the second level available. For example, if in the above example a slightly positive rating results for the genre ‘series’, and a broadcast program is merely categorized as ‘series’, the program may be recommended if said rating exceeds a predetermined recommendation threshold.

An variant of the method according to the invention is characterized in that the rating of the category of the first level is computed as the average of the ratings of subordinate categories of the second level. This provides a very intuitive relationship between ratings of the first and second level, respectively. For example, if half of the ratings of the second level express a preference and the other ratings of the second level express a dislike, one would intuitively expect a fairly neutral rating at the first level, which is indeed achieved by averaging the ratings of the second level.

An variant of the method according to the invention is characterized in that the method further comprises a step of visually representing a rating by means of a color. This provides a more convenient and appealing way of representing ratings than just numerical values. This maybe applied, for example, in the graphical user interface of an electronic program guide, to color program data in accordance with their ratings.

A preferred variant of the method according to the invention is characterized in that a plurality of ratings is represented by means of a single color, a parameter of said color corresponding to a respective one of said plurality of ratings. For example, all programs in an EPG of a genre having a positive rating may be colored green, while programs of a disliked genre may be colored red. The distinction between various degrees of preference or dislike may be indicated by varying the said parameter of the respective color. Advantageously, said parameter is the color saturation, which results in deep colors for high degrees of preference or dislike, respectively, and pale colors for low degrees. Hence, programs having a deep green color are highly recommended, while programs having a pale green color are only moderately recommended. Ratings of both the first and second level may be represented in this way.

The invention is particularly suitable for systems for receiving and/or playing audio or video programs, such as a television receiver, an audio jukebox etc. The method according to the invention may also be applied to for target advertisements and other information to the proper audience, by building user profiles expressing preference or dislike for certain product categories.

The user may wish to assign a rating to a category of the first level, instead of rating the individual subordinate categories. In that case, the latter ratings may be generated or modified automatically in order to maintain the functional relationship between the first and second level. For example, if the rating of the first level is the average of the subordinate ratings, the subordinate ratings may be made equal to the rating of the first level, or modified in such a way that their average equals the rating of the first level.

The method according to the invention is not restricted to a category scheme of only two levels. Categories of the second level may in turn have further subordinate categories, and so on. Said function for computing a rating may be applied to each pair of adjacent levels. The result of such a computation may then serve as an input to the computation of a rating at a still higher level.

### BRIEF DESCRIPTION OF THE DRAWINGS

These and other aspects of the invention are apparent from and will be elucidated, by way of a non-limitative example, with reference to the embodiment(s) described hereinafter. In the drawings,

FIG. 1 shows a diagram of a TV-set as an apparatus embodying the invention,

FIG. 2 shows an example of a screen for editing a user profile according to the invention,

FIG. 3 shows an example of an EPG screen utilizing the ratings system according to the invention.

### DESCRIPTION OF EMBODIMENTS

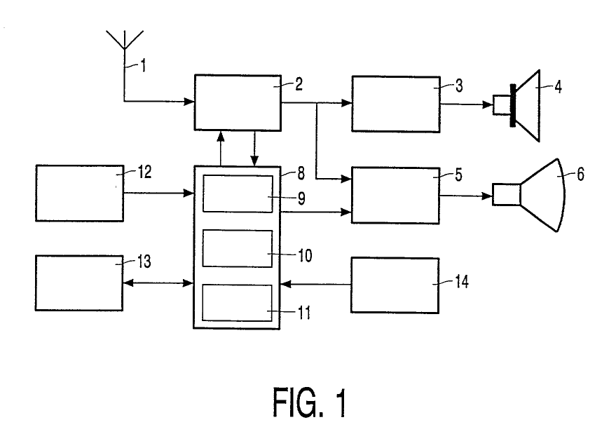

FIG. 1 shows a diagram of a TV-set as an apparatus embodying the invention. TV signals are received from the ether by an antenna 1 or, alternatively, from a cable network. One of the TV signals is selected by a tuner 2, decoded and split into an audio signal, a video signal and a data signal. The audio signal is further processed by an audio processor 3 and a loudspeaker 4. The video signal is further processed by a video processor 5 and presented on a screen 6. The data signal is transmitted to a central processing unit (hereinafter “CPU”) 8, which comprises one or more microprocessors capable of executing program instructions stored in a read-only memory (hereinafter “ROM”) 14. These program instructions comprise parts of software modules including, inter alia, a user command module 9, an EPG module 10 and a profile module 11, which may be operating simultaneously in the CPU 8. Data processed by said software modules, e.g. EPG data and user profile information, may be stored in a non-volatile memory 13. The CPU 8 is capable of controlling functions of the TV-set and transmitting data to the video processor 5 to be presented on the screen 6. A user control unit 12, for example a remote control, receives user commands, and transmits them to the CPU 8 to be processed by the user command module 9. For example, when the user enters a channel number the CPU 8 controls the tuner 2 to select the corresponding channel, and sends data to the video processor 5 to present feedback on the screen 6, e.g. the preset number, the channel name and the program category being displayed for a few seconds.

The data signal is decoded from the TV signal by means of a teletext decoder (not shown), and includes, inter alia, EPG data which provide an overview of programs scheduled for the near future. The EPG data may comprise for each program attributes such as a title, the start time and duration, the channel number, and genre information. In response to a predetermined user command, the EPG module 10 is invoked to present a program schedule on the screen 6, as will be described hereinafter.

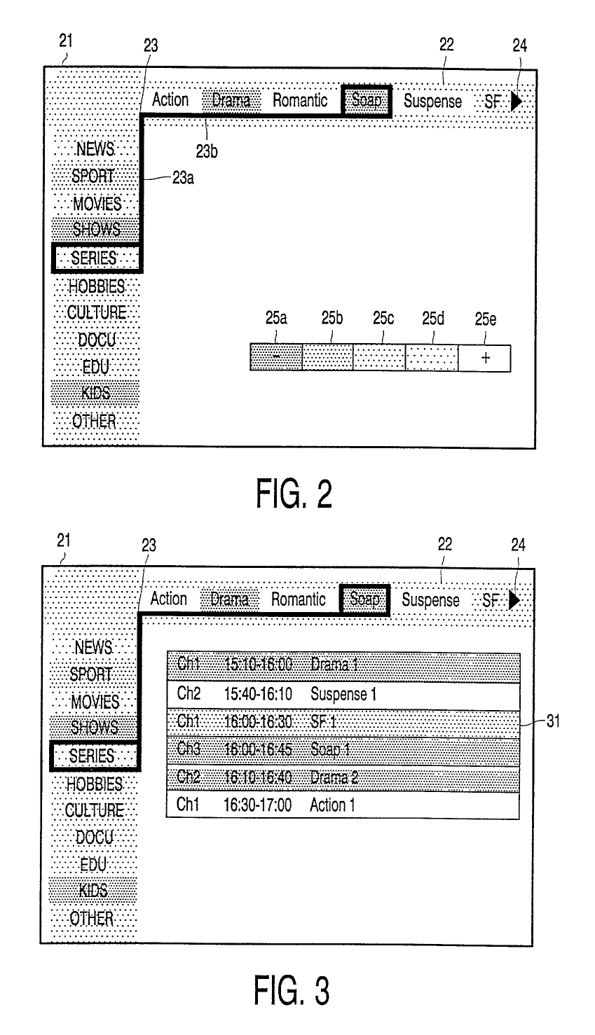

FIG. 2 shows an example of a screen for editing a user profile according to the invention. A first display area 21 comprises labels of a plurality of main genres, such as News, Sport, Series etc. This main genre menu represents the first level of a two-level genre filter menu for filtering program data from an EPG database. A second display area 22 comprises labels of a plurality of subgenres which are subordinate to a selected main genre in the first display area 21. In the example the main genre ‘Series’ is selected and the second display area 22 comprises labels of more specific categories of series, such as Action, Drama, Soap etc. As is clear from FIG. 2, the second display area 22 has a fixed position with respect to the first display area 21, independent of the selected menu item in the latter area. Instead, a connection indicator 23 is displayed, indicating the relation between the selected main genre, i.e. ‘Series’, and the selected subgenre, i.e. ‘Soap’. The connection indicator 23 comprises the lines 23a and 23b.

Selecting another main genre, e.g. ‘Culture’ would elongate the line 23a so as to connect the label ‘Culture’ with the second display area 22 (but not with a specific subgenre, i.e. line 23b is not displayed). As soon as the user selects a subgenre of said selected main genre, the connection indicator 23b is displayed to connect the label ‘Culture’ with the selected subgenre label, analogous to the situation as depicted in FIG. 2.

An arrow 24 indicates that there are more subgenres than can be displayed in the second display area 22. The subgenres may be scrolled, for example, by operating the left/right arrow buttons on a remote control. Likewise, the main genres could be scrolled, if needed, by operating the up/down arrow buttons. While scrolling, the selected (sub)genre may remain the same, or preferably, the selection ‘jumps’ to the neighboring label in the scroll direction. Such techniques for scrolling and selection are known per se and widely applied.

The text labels indicating the various genres and subgenres have varying background colors (varying gray scales in FIG. 2), indicating different rating values. Alternatively or additionally, the text labels may have varying foreground colors or may be distinguishable in other ways to indicate different rating values. The underlying ratings can be chosen from a five-point scale, ranging from −2 to +2, by means of a selection bar 25a-25e, which can be operated with the left/right arrow buttons of a remote control. A rating of −2 indicates a strong dislike and is represented by a dark background. In the example, the subgenres Drama and Soap have such a negative rating. A zero rating indicates a neutral position, represented by a neutral or transparent background, and in the example it is assigned to the subgenre SF. A rating of 2 indicates a strong preference and is represented by a white background. In the example, the subgenres Action, Romantic and Suspense have such positive ratings.

Based on the ratings of the subgenres, a rating of the related main genre is computed. In the example, the genre Series has a slightly positive rating, as a result of averaging the ratings of the related subgenres. The genres News and Movies have the same slightly positive rating, while the genres Shows and Kids have negative ratings, all based on ratings of subordinate genres which are not currently selected, hence not shown in FIG. 2.

If there is no subgenre selected (line 23b is not displayed as described above), the user can assign a rating directly to a main genre. As a result, the ratings of the related subgenres will be made equal to the newly supplied rating of the main genre, so the functional relationship (i.e. the rating of a genre is the average of the ratings of its subgenres) is guaranteed. The colors on the screen will adapt to the newly generated ratings. Alternatively, the system may attempt to preserve the mutual differences of the subgenres, by increasing or decreasing their ratings by a certain amount in such a way that the average rating equals the newly supplied rating of the main genre.

In a preferred embodiment, different colors are used for positive and negative ratings. For example, positive ratings may be represented by a green color with various degrees of saturation, while negative ratings may be represented by a red color, also with various degrees of saturation. Additional colors may be dedicated to various subranges ad libitum.

The colors thus established for the respective genres and subgenres are used to enhance the usability of other components of the TV-set. For example, program listings generated by the EPG module 10 may use the same colors to indicate the rating of the corresponding genre. FIG. 3 shows an example of a program listing of all programs of the genre Series. For consistency and ease of understanding, the same reference numerals of FIG. 2 are used for items serving a function similar to those presented in FIG. 1. No specific subgenre is selected, hence programs of all kinds of subgenres are included in the list. The list of programs is displayed in an area 31. Each program has a background color which corresponds to the rating of the related subgenre. In this way the user sees at a glance which programs are most likely to be appreciated by him, and which programs are not.

Although the invention has been described with reference to particular illustrative embodiments, variants and modifications are possible within the scope of the inventive concept. Thus, for example, instead of colors, textures or patterns may be used to visually represent ratings. Such representations may also be applied to systems having a category scheme of only one level, e.g. a user profile which allows the user to assign ratings to main categories only. Instead of averaging the ratings of subordinate categories, one could take the median of said ratings, and/or exclude the most extreme ratings from the computation. The result of the computation may be rounded off to the nearest integer.

In summary, the invention relates to a method of rating database objects, such as broadcast programs in an EPG database. The objects are categorized in accordance with a multi-level category scheme with a first level of categories and a second level of categories subordinate to a respective category of the first level. The rating of a category of the first level is computed as a function , for example the average, of ratings of subordinate categories of the second level. Ratings are visually represented as different colors or different degrees of saturation of the same color.

The use of the verb ‘to comprise’ and its conjugations does not exclude the presence of elements or steps other than those defined in a claim. The invention can be implemented by means of hardware comprising several distinct elements, and by means of a suitably programmed computer. In the device claim enumerating several means, several of these means can be embodied by one and the same item of hardware.

A ‘computer program’ is to be understood as any software product stored on a computer-readable medium, such as a floppy-disk, downloadable via a network, such as the internet, or marketable in any other manner.

1. A method of rating database objects, comprising a step of categorizing the objects into a plurality of categories, and a step of rating at least one of said categories, characterized in that the method further comprises a step of arranging the categories in accordance with a multi-level category scheme with a first level of categories and a second level of categories subordinate to a respective category of the first level, and a step of computing a rating of a category of the first level as a function of ratings of subordinate categories of the second level.

2. A method as defined in claim 1, characterized in that the rating of the category of the first level is computed as the average of the ratings of subordinate categories of the second level.

3. A method as defined as defined in claim 1 or 2, characterized in that the method further comprises a step of visually representing a rating by means of a color.

4. A method as defined in claim 3, characterized in that a plurality of ratings is represented by means of a single color, a parameter of said color corresponding to a respective one of said plurality of ratings.

5. A method as defined in claim 4, characterized in that said parameter is the saturation of said color.

6. A method as defined in any one of claims 1 to 5, characterized in that the objects are programs in an electronic program guide (EPG) database, and the categories of the first and second level are genres and sub-genres of said programs, respectively.

7. An apparatus for processing database objects, said objects being categorized into a plurality of categories, the apparatus comprising user profile means for rating at least one of said categories, characterized in that the user profile means are further adapted to arrange said categories in accordance with a multi-level category scheme with a first level of categories and a second level of categories subordinate to a respective category of the first level, and to compute a rating of a category of the first level as a function of ratings of subordinate categories of the second level.

8. An apparatus as defined in claim 7, characterized in that the rating of the category of the first level is computed as the average of the ratings of subordinate categories of the second level.

9. An apparatus as defined in claim 7 or 8, characterized in that the apparatus further comprises a display screen and the user profile means are adapted to visually represent a rating by means of a color.

10. An apparatus as defined in claim 9, characterized in that a plurality of ratings is represented by means of a single color, a parameter of said color corresponding to a respective one of said plurality of ratings.

11. An apparatus as defined in claim 10, characterized in that said parameter is the saturation of said color.

12. A broadcast receiver as an apparatus as defined in any one of claims 7 to 11, said objects being programs in an electronic program guide (EPG) database, and the categories of the first and second level being genres and sub-genres of said programs, respectively.

13. A computer program product for performing, when executed on a programmable computing device, the steps of the method as defined in any one of claims 1 to 6.
